(19) United States
(12) Patent Application Publication
(10) Pub. No.: US 2007/0290790 A1
(43) Pub. Date: Dec. 20, 2007

(54) Lock Programming Device

(75) Inventors: Kevin D. Miller, Avon, CT (US); George Frolov, Farmington, CT (US); Mark A. Caterino, Prospect, CT (US)

Correspondence Address: MICHAEL BEST & FRIEDRICH LLP, 100 EAST WISCONSIN AVE, SUITE 3300, MILWAUKEE, WI, 53202-4108, US

(73) Assignee: HARROW PRODUCTS LLC, MONTVALE, NJ (US)

(21) Appl. No.: 11/665,910

(22) PCT Filed: Oct. 20, 2005
(86) PCT No.: PCT/US05/37726

§ 371 Date: Apr. 20, 2007

Related U.S. Application Data
(60) Provisional application No. 60/620,622, filed on Oct. 20, 2004.

(51) Int. Cl. H04B 1/00

(52) U.S. Cl. 340/5.22

(57) ABSTRACT

A lock programming device (10) is for use with a lock system (40) including a computer (2) and a one door lock(s) having a control. The computer has RAM (6), a storage device (7), and a program for generating lock code data files in response to user input. The lock control has memory (4a) for storing a lock code data file(s) and is configured to operate the lock when receiving input corresponding to the code file. The programming device (10) includes a base (12) disposeable in a user's hand and a flash memory (14) connected with the base for storing at least one data file. A controller (16) connected with the base is coupled with the flash memory and coupleable with the computer. The controller communicates with the computer to write a data file in RAM directly to the flash memory and communicates with the lock control to transfer the data file from the flash memory to the lock memory.

The present invention relates to electronic lock systems, and more specifically to devices used to provide access control information to such electronic locks.

Electronic or electromagnetic locks typically include a control with a memory that contains one or more codes and an input device (e.g., keypad, card reader) connected with the control. When the lock control receives an authorized input matching or corresponding with a lock code in the control memory, the lock is adjusted to an open configuration. Typically, such lock codes are either manually entered into the memory through the input device or through a computer connected with the lock memory.

### SUMMARY OF THE INVENTION

In one aspect, the present invention is a lock programming device for use with a lock system, the lock system including a computer and at least one door lock having a control. The computer has a random access memory, a storage device, and a program loadable into the random access memory for generating data files in response to user input, each data file corresponding to at least one lock code. The lock control has a memory for storing at least one lock code data file and is configured to operate the lock when the control receives an input corresponding to the stored code file. The programming device comprises a mobile base, preferably sized to be generally disposed within a hand of a user, and a flash memory connected with the base and configured to store at least one data file. A controller is connected with the base, coupled with the flash memory and coupleable with the computer. The controller is configured to communicate with the computer such that a data file located in the random access memory is writable generally directly to the flash memory, and configured to communicate with the lock control such that the data file is transferable from the flash memory to the lock control memory.

In another aspect, the present invention is again a programming device for use with a lock system, the lock system being as described above and having an operating system. The programming device comprises a mobile base sized to be generally disposed within a hand of a user and a flash memory connected with the base. The flash memory is configured to store at least one data file and is coupleable with the computer. The flash memory is recognizable by the computer operating system as a storage device such that a data file located in the random access memory is writable generally directly to the flash memory. Further, the flash memory is configured to communicate with the lock control such that the data file is transferable from the flash memory to the lock control memory.

In yet another aspect, the present invention is also a lock system comprising a computer having a random access memory, a storage device, and a program loadable into the random access memory for generating data files in response to user input, each data file corresponding to at least one lock code. A lock includes a control having a memory for storing at least lock code data file, the lock control being configured to operate the lock when the control receives an input corresponding to the stored code file. Further, a programming device includes a mobile base sized to be generally disposed within a hand of a user and a flash memory connected with the base, the flash memory being configured to store at least one data file. The programming device is configured to communicate with the computer, such that a data file located in the random access memory is writable generally directly to the flash memory, and configured to communicate with the lock control such that the data file is transferable from the flash memory to the lock control memory.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a schematic diagram of a lock programming device for use with a lock system, in accordance with the present invention;

FIG. 2 is a perspective view of the programming device coupled with a computer of, the lock system;

FIG. 3 is a side elevational view of the programming device coupled with one lock of the lock system, shown mounted on a door;

FIG. 4 is a logic flow diagram of the programming device as incorporated into the lock system;

FIG. 5 is an enlarged, perspective view of a presently preferred construction of the programming device;

FIG. 6 is a side plan view of the programming device of FIG. 5, shown coupled with a lock interface device;

FIG. 7 is an exploded view of the preferred construction programming device of FIG. 5;

FIG. 8 is a front plan view of a circuit board of the programming device;

FIG. 9 is a rear plan view of the circuit board of FIG. 8;

FIG. 10 is a top plan view of an alternative construction of the programming device;

FIG. 11 is a cross-sectional view through the alternative construction programming device of FIG. 10;

FIG. 12 is a more diagrammatic view of the programming device and the computer;

FIG. 13 is a more diagrammatic view of the programming device and the lock; and

FIG. 14 is a more diagrammatic view of the alternative construction programming device and the lock.

### DETAILED DESCRIPTION OF THE INVENTION

Certain terminology is used in the following description for convenience only and is not limiting. As used herein, the words “connected” and “coupled” are each intended to include direct connections between two members without any other members interposed therebetween, indirect connections between members in which one or more other members are interposed therebetween, and operative or functional connections in which a physical connection may or may not exist. Also, the word “program” as used herein includes any and all types of computer programs, software, series of instructions, etc., that a computer can interpret and execute. The terminology includes the words specifically mentioned above, derivatives thereof, and words of similar import.

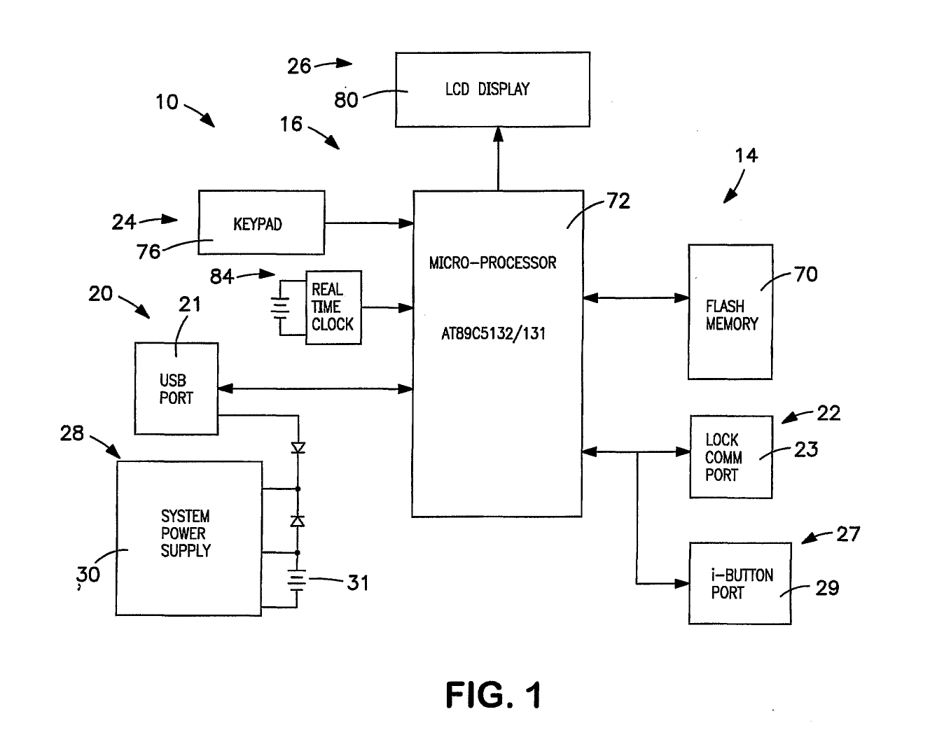

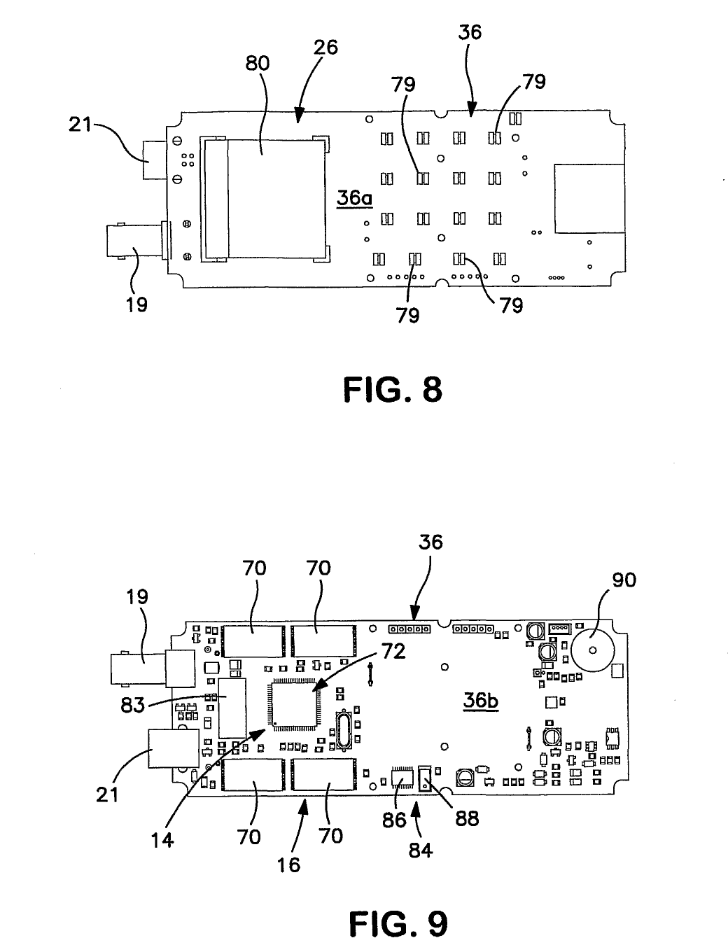

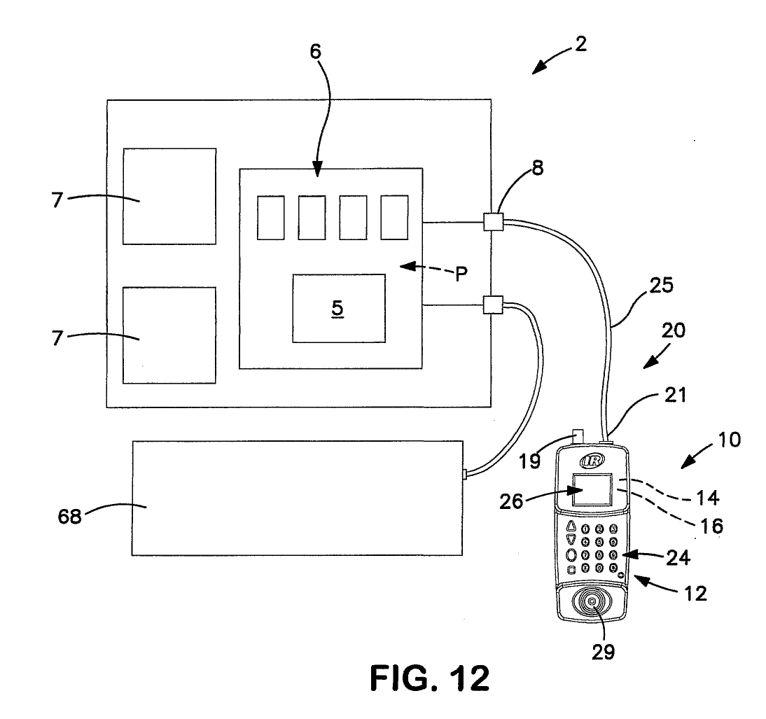

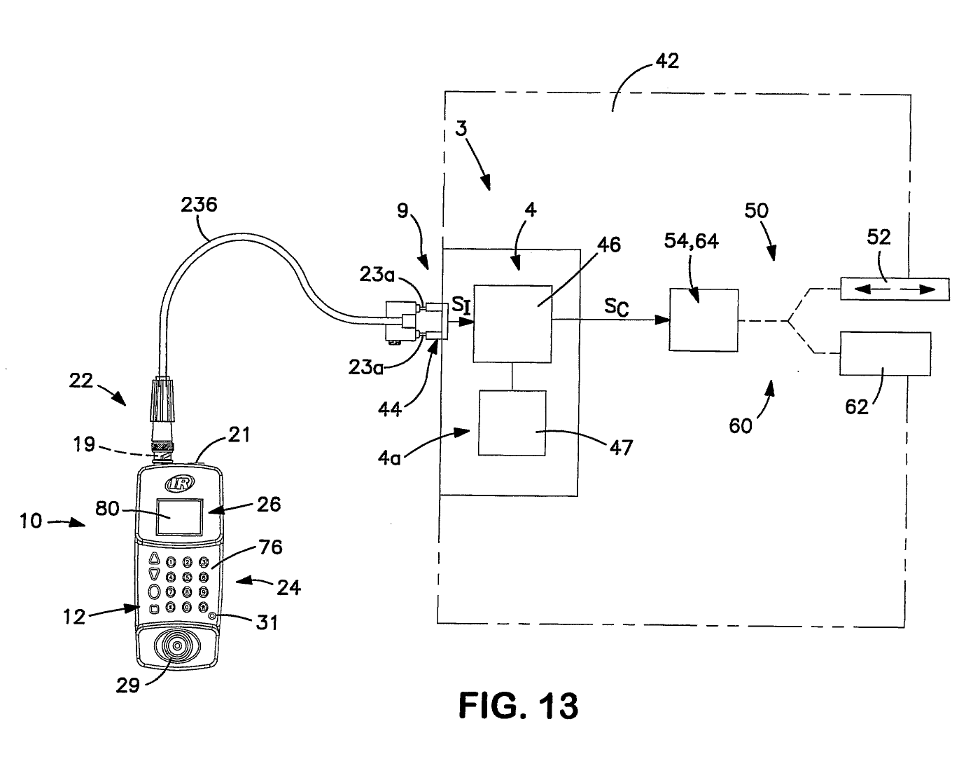

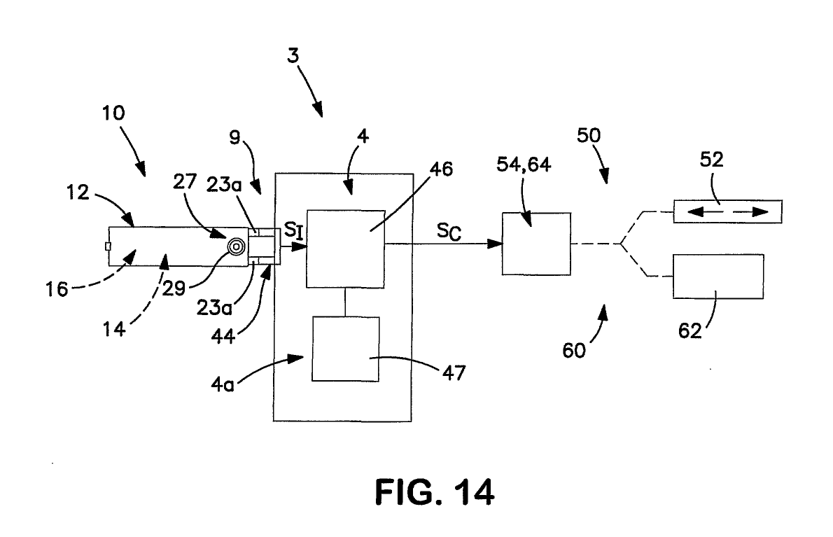

Referring now to the drawings in detail, wherein like numbers are used to indicate like elements throughout, there is shown in FIGS. 1-14 a lock programming device 10 for use with a lock system 1 that includes a computer 2 and at least one and preferably a plurality of door locks 3 each having a control 4. The computer 2 preferably has a central processing unit 5 or “CPU” connected with random access memory or “RAM” 6, at least one storage device 7, and one or more programs P (FIG. 12) loadable into the RAM 6 and configured to generate one or more data files F_{L} in response to user input, each file F_{L} including at least one lock code C_{L}. Such a computer program P for generating lock code files F_{L} may be a text editor, a word processor, an application specific program, etc. Further, each lock control 4 has a memory 4a for receiving and storing at least one data file F_{L} containing at least one lock code C_{L}, and is configured to operate the lock 3 when the control 4 receives an input I_{U} corresponding to one of the stored lock code(s) C_{L}.

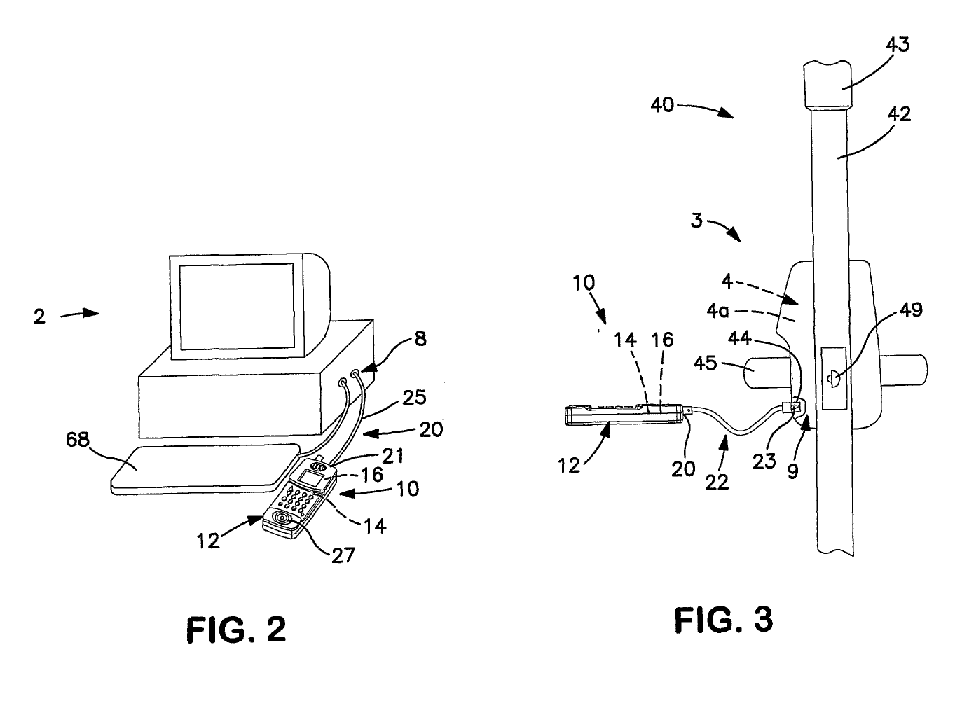

The programming device 10 basically comprises a mobile base 12 and a flash memory 14 connected with the base 12, and preferably also comprises a controller 16 connected with and/or mounted to the base 12, coupled with the flash memory 14 and coupleable with the computer 2. The base 12 is preferably sized to be generally disposed within a hand of a user, such that the programming device 10 is readily transportable between the computer 2 and the one or more locks 3. In other words, the base 12 is movable between a first location generally proximal to the computer 2 (FIGS. 2 and 12) and at least one second location generally proximal to one of the locks 3 (FIGS. 3, 13 and 14), and preferably to a plurality of separate locks 3 at different second locations (e.g., doorways, secured cabinets, etc.). The flash memory 14 is configured to receive and store at least one and preferably a plurality of data files F_{L}, and is coupleable with the computer 2 (preferably through the controller 16) so as to be recognizable by the operating system as a storage device. Further, the controller 16 is configured to communicate with the computer 2 such that a data file F_{L} located in the RAM 6 is writable generally directly to the flash memory 14 and is configured to communicate with the lock control 4 such that the data file F_{L} is transferable from the flash memory 14 to the lock control memory 4a.

More specifically, the computer 2 has an operating system (e.g., Windows, MAC O.S., Unix, VMS, etc.) configured to directly write one or more data files F_{L} from the RAM 6 to the flash memory 14 when the controller 16 is coupled with the computer 2. Each such data file F_{L} located in the RAM 6 is either generated by the computer file-generation program P and sent directly to the flash memory 14 or is first retrieved from a storage device 7 (i.e., hard drive, diskette, ZIP drive, etc.), having been previously created by the program P. Further, the operating system is configured to recognize the programming device 10 as a storage drive coupled with the CPU 5 when the controller 16 is coupled with the computer 2. As such, the programming device 10 of the present invention provides the benefit of eliminating the need for any special software for communication, or file transference, between the device 10 and the computer 2.

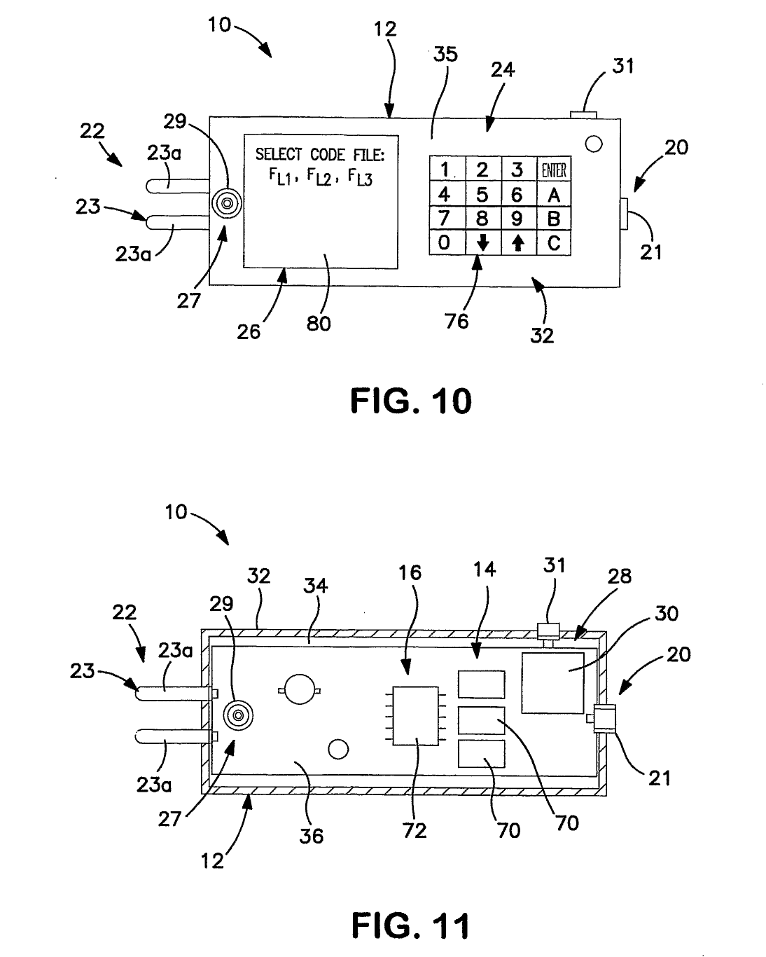

Preferably, the programming device 10 further comprises a first interface device 20 electrically connected with the controller 16 and coupleable with the computer 2, which preferably includes a universal serial bus or “USB” port 21. More specifically, the computer 2 preferably has a USB port 8 and the programming device USB port 21 is electrically connectable with computer port 8 by means of a USB cable 25. Alternatively, the device 10 and the computer 2 may be connected by any other standard electrical connection (e.g., serial ports), by a wireless transceivers, or any other appropriate means for transferring the data files F_{L}. With the preferred structure, the computer 2 preferably transmits the one or more data files F_{L} from the RAM 6, through the coupled USB ports 8 and 21, to the controller 16 and thereafter to the flash memory 14. Such file transference is enabled by USB software that is typically included in most commercially available operating systems, such as the various Microsoft Windows® systems. Furthermore, the programming device 10 preferably also comprises a second interface device 22 electrically connected with the controller 16 and electrically connectable with the lock control 4, and preferably includes a serial connection device 23. Most preferably, the serial connection device 23 includes a BHN connector 19 mounted on the base 12 and coupled with the controller 16 and a cable assembly 23b releasably connectable with the BHN connector 19 and including two “iButton” pins 23a. The two iButton pins 23a are insertable within an iButton serial port 9 electrically connected with the lock control 4. As such, the controller 16 transmits data files F_{L} from the flash memory 14, through the BHN connector 19 and coupled iButton pins 23a, into port 9 and to the lock control 4, as discussed in further detail below. Alternatively, as shown in FIGS. 10, 11 and 14, the programming device 10 may be constructed with iButton pins 23a fixedly connected with the base 12 and directly electrically connected with the controller 16, such that no cable assembly is required.

Additionally, the flash memory 14 is preferably configured to store a plurality of the data files F_{L}, each file F_{L} including at least one and a preferably a plurality of separate lock codes C_{L}, as discussed above and in greater detail below. As such, the programming device 10 preferably further comprises an input device 24 coupled with the controller 16 and configured to operate the controller 16 to separately select each one, or a group, of the data files F_{L} from the flash memory 14 and to transmit the one or more selected data files F_{L} to the lock control 4. The input device 24 includes a keypad (as depicted), a keyboard, a touchscreen, a pushbutton, or any other appropriate device for providing an input to the controller 16. Further, the programming device 10 also preferably comprises a display 26 operably coupled with the controller 16 and configured to provide information to a user of the device 10, which may include a liquid crystal display screen, a light emitting diode (none shown) or any other appropriate indicator device. Furthermore, the controller 16 is configured to generate and transmit to the display 26 one or more visual indications (e.g., text messages) to provide information to a user, as depicted in FIG. 10. Such information may include an indication identifying each data file F_{L} stored within the flash memory 14, an indication of the status of a file transmission from the flash memory 14 to the lock control 4 (e.g., “file sending” or “file sent” text message, etc.), and/or any other appropriate information that may assist a user when “uploading” data files from the computer 2 to the flash memory 14, or “downloading” files to the lock control 14, and vice-versa, or otherwise.

Furthermore, the programming device 10 also preferably comprises an authorization input device 27 coupled with the controller 16 and/or coupleable with the lock control 4. In certain system constructions, either the controller 16 or/and the lock control 4 may be configured to require an authorization code from a user prior to enabling a transference of one or more data files F_{L} (or audit trail information) between the flash memory 14 and the lock control 4. As such, the authorization device 27 is configured to provide an authorization code to either or both of the controller 16 and the lock control 4. Preferably, the authorization device 27 includes an iButton reader 29 connected with the base 12, configured to receive an iButton key (not shown), and electrically connected with the controller 16 and with the iButton pins 23a. As such, the reader 29 is electrically connected with the lock control 4 when the pins 23a are inserted within the lock serial port 9 and the cable assembly 23b is coupled with the BHN connector 19, when necessary. With this construction, an authorization code stored within an iButton key may be transmitted to either/both of the controller 16 and the lock control 4 to ensure that only an authorized user may program the lock 3.

As shown in FIGS. 1, 7 and 11, the programming device 10 also further comprises a power supply 28 connected with the base 12 and electrically connected with the controller 16 (and other powered components), and preferably includes one or more batteries 30 and a power switch or button 31. The power supply 28 is preferably also electrically connected with the USB port 21 and is configured to alternately draw power from the batter(ies) 30 or from the computer 2 (i.e., when coupled therewith). Specifically, the power supply 28 preferably includes a regulator (not depicted) configured to draw electric current from the one or more batteries 30 when the battery voltage is greater than the voltage at the USB port 21. Alternatively, the power supply regulator draws current from the computer 2, through the USB port 21, when the voltage at the USB port 21 is greater than the battery voltage. As such, the energy contained within the preferred batter(ies) 30 is conserved so as to prolong the useful life thereof.

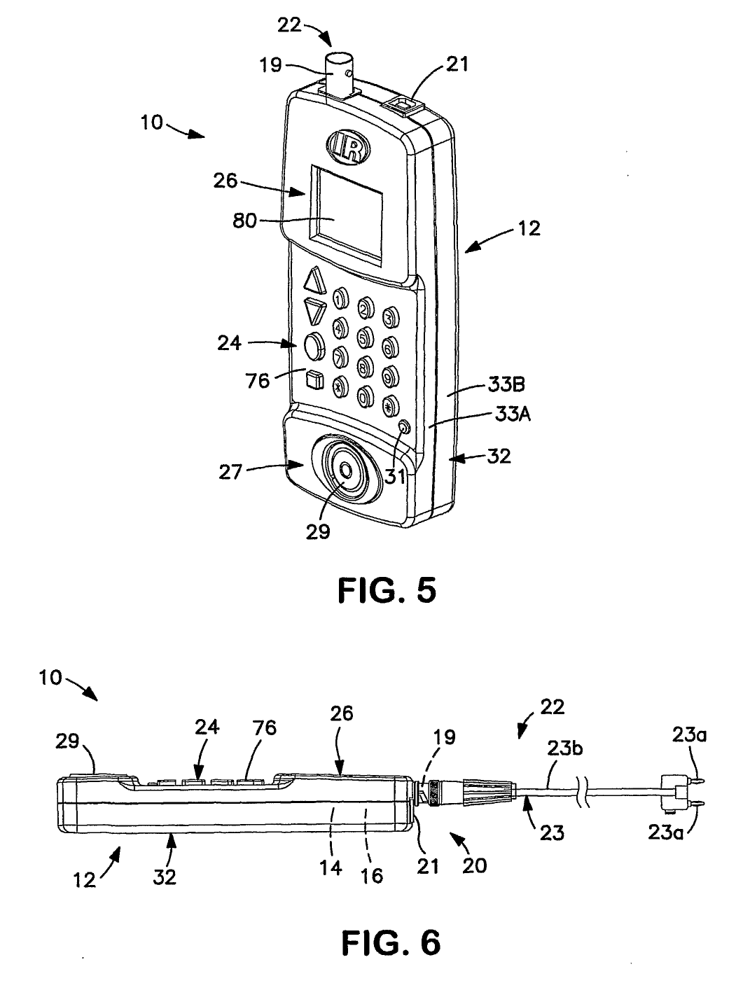

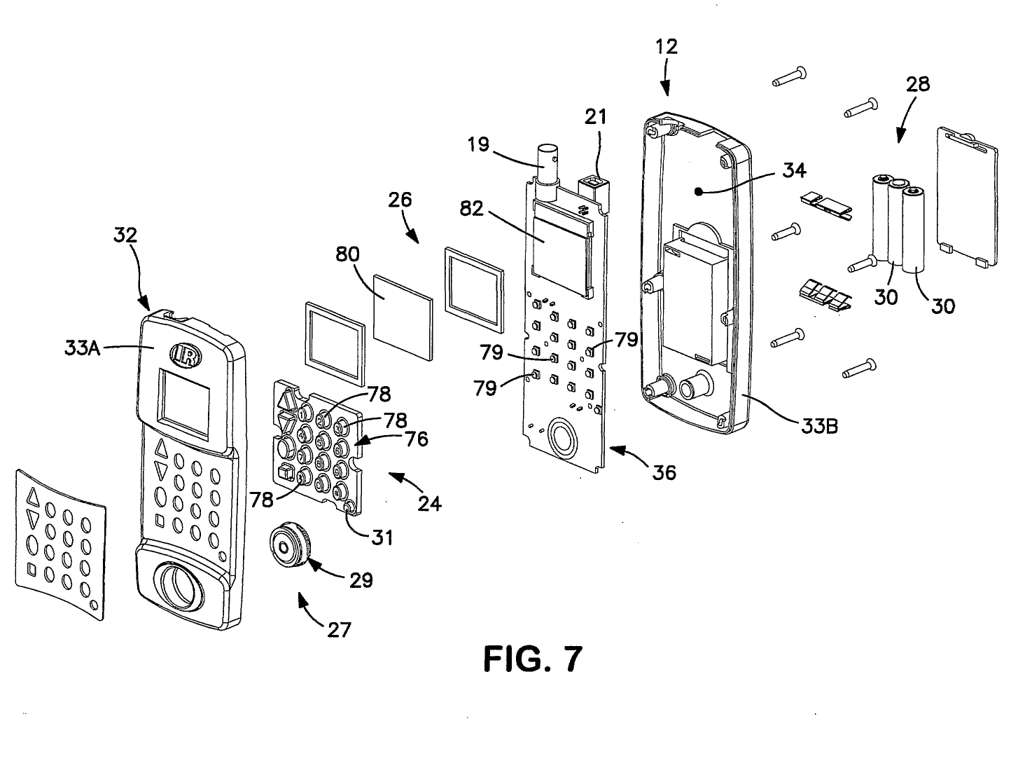

Referring particularly to FIGS. 5-7, the base 12 preferably includes a housing 32 having an interior cavity 34, the flash memory 14 and the controller 16 being generally disposed or housed within the cavity 34. The housing 32 may have any appropriate shape and is preferably sized to fit within a user's hand, such that the base 12 is readily movable between a first location proximal to the computer 2 and a second location proximal to the lock 3. Although not presently preferred, the housing 32 and/or base 12 may alternatively be sized to be carried by a user, such as provided with a carrying case or carry strap (neither depicted), but not sized to directly disposeable within a user's hand or palm. Preferably, the housing 32 is formed of front and rear, generally rectangular shell halves, 33A, 33B, respectively, connected together to define the cavity 34, as best shown in FIG. 7.

As best shown in FIGS. 7-9 and 11, the base 12 also preferably includes a circuit board 36 disposed within the cavity 34 and enclosed within the housing 32, the board 36 having front and rear mounting surfaces 36a, 36b. Preferably, at least the flash memory 14, the controller 16, and the power supply 28 are each mounted to and/or connected with the circuit board 36, as discussed further below. Further, the coupling elements of the USB port 21 and at least part of the serial port 22 each preferably extends through openings (not indicated) in the housing 32, and the input device 24 and the display 26 are both mounted to the housing exterior surface 35, or extend through openings within the housing 32. Each such component 20, 22, 24, 26 is preferably electrically connected with the circuit board 36. However, the ports 21 and 22, input device 24, or/and the display 26 may be connected with the base 12, and operatively coupled with the controller 16, through cables 27 or other appropriate connective means.

Having described the basic elements of the present invention, these and other components of the programming device 10, and the lock system 1 incorporating the device 10, are discussed in greater detail below.

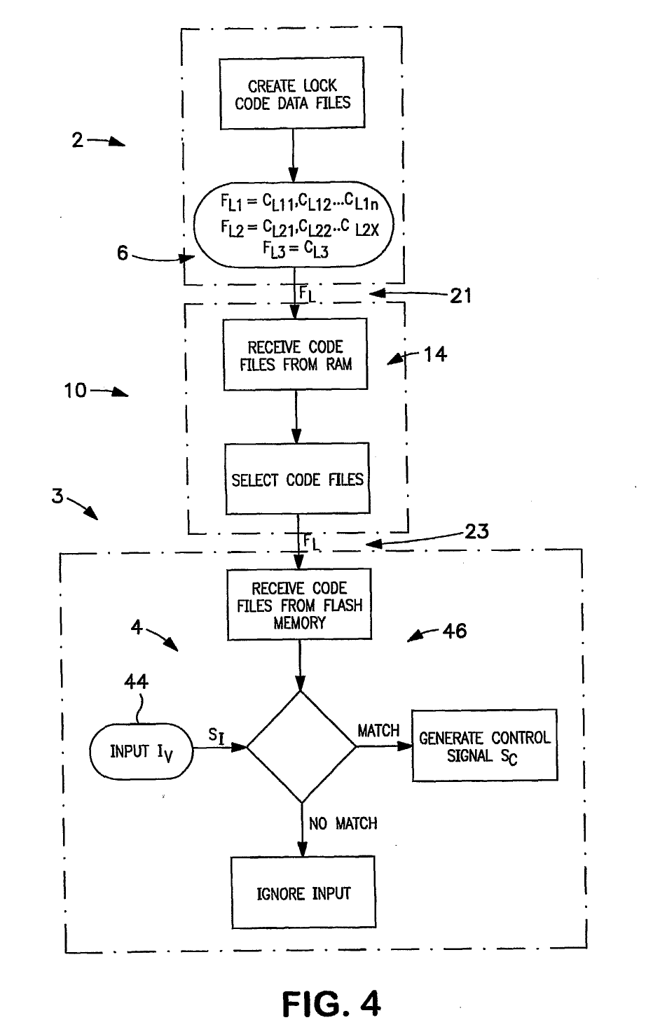

Referring first to FIGS. 3, 4, 13 and 14, as discussed above, the lock system 1 preferably includes a plurality of locks 3 (only one depicted), each controlling access through a separate doorway 40 or any type of “controlled accessway” (e.g., storage locker, drawer, cabinet, window, etc.). Most preferably, each lock 3 is at least partially mounted on a door 42 movably disposed within a frame 43, the door 42 being displaceable between open and closed positions with respect to the frame 43. The preferred locks 3 are each adjustable between a first configuration, at which the lock 3 secures the associated door 42 within its frame 43, and a second configuration at which the door 42 is displaceable with respect to the frame 43, as described below. Further, each lock 3 also includes an input device 44 electrically connected with the lock control 4 and configured to receive user input I_{U} (FIG. 4) and to generate and transmit to the control 4 an electrical signal S_{I} corresponding to the user input I_{U}. The input device 44 may include a keypad, a card reader, an iButton serial port, a wireless receiver/transceiver or any other appropriate device for receiving user input I_{U} and providing the input to the lock control 4. Most preferably, the input device 44 is provided by the same iButton serial port 9 used to receive data files F_{L} from the programming device 10, as discussed above and in further detail below.

Furthermore, each lock control 4 is preferably configured to operate the associated lock 3 when the control 4 receives a user input I_{U} (i.e., signal S_{I}) corresponding to any of one or more lock codes C_{L} stored in the control memory 4a. Preferably, the lock control 4 includes a microprocessor 46 and one or more memory chips 47. The microprocessor 46 is configured to receive the input signal S_{I} and to compare at least a portion of the signal S_{I} to the one or more stored lock codes C_{L}, which are stored in the memory chip(s) 47. When the microprocessor 46 determines that there is a “match”, or other appropriate correspondence or correlation, between at least a portion of the input signal S_{I} and one of the stored lock codes C_{L}, the microprocessor 46 generates a control signal S_{C}. The control signal S_{C} is transmitted to a lock actuator 52, a control switch 64, or other device for “opening” the lock 3, as discussed below. However, if microprocessor 46 determines that there is no correspondence between the input I_{U} and any lock code C_{L} stored in the lock memory 47, the microprocessor 46 may either take no further action, or generate a signal to activate an appropriate device (none shown) to indicate that the input I_{U} is unauthorized or incorrect. Further, the microprocessor 46 is electrically connected with the lock serial port 9 and is configured to communicate with the programming device controller 16 to transfer data files F_{L} through the coupled serial ports 23 and 9 to the lock control memory 4a. Although the microprocessor 46 is preferred, the lock control 4 may alternatively include an analog circuit or any other logic components or structure capable of enabling the control 4 to function generally as described herein.

Referring to FIGS. 3, 13 and 14, in one exemplary construction, one or more locks 3 may each be an electro-mechanical lock 50 including a moveable lock member 52 and an actuator 54 for displacing the member 52. Specifically, the lock member 52 is displaceable between a first, locked position and a second, unlocked position, and the actuator 54 is configured to displace the lock member 52 between the two positions. The moveable member 52 may be part of clutch device (not shown) configured to releasably connect an exterior handle 45 with a latch or bolt 49 (see FIG. 3), or a “blocking” device (not shown) configured to prevent movement of the exterior handle 45, the latch/bolt 49, or an intermediate component (e.g., retractor mechanism) until moved to the unlocked position. In either case, the actuator 54 displaces the moveable member 52 to the unlocked position when the actuator 54 receives the control signal S_{C} from the lock control 4, such that the exterior handle (and/or interior handle) may be used to displace the latch/bolt 49 to open the door 42. Thereafter, the actuator 54 either retains the moveable member 52 at the unlocked position until receiving a second control signal from the control 4 or is configured to automatically return the member 52 to the locked position after a predetermined time period.

In another exemplary construction, one or more locks 3 may each be an electro-magnetic lock 60 including an electromagnet 62 configured to releasably secure the door 42 within the frame 43 and a control switch 64 (e.g., a relay) controlling the supply of electric power to the electro-magnet 62. The electro-magnet 62 is adjustable between a powered state, at which the door 42 is magnetically secured to the frame 43, and an unpowered state at which the door 42 is displaceable with respect to the frame 43. The control switch 64 is electrically coupled with the electro-magnet 62 and with a power supply 64, and is operably connected with lock control 4 (i.e., the microprocessor 46). The switch 64 removes or “shuts off” electric power to the electro-magnet 62 when the switch 64 receives the control signal S_{C} from the lock control 4, such that the door 42 may be displaced relative to the frame 43. Thereafter, the switch 64 either returns power to the electromagnet when receiving a second control signal from the lock control 4 or automatically after a predetermined time period.

It must be emphasized that the above-described electro-mechanical lock(s) 50 and electro-magnetic lock(s) 60 are only exemplary constructions of the one or more locks 3 of the lock system 1. Further, it is within the scope of the present invention to use the programming device 10 with any other appropriate type of lock constructed in any appropriate manner so as to be programmable by the device 10 as generally described herein.

Referring now to FIGS. 2 and 12, the computer 2 may be any appropriate digital computing device, such as a standard desktop PC, laptop computer, personal digital assistant or any other similar, appropriate device. Preferably, the operating system of the computer 2 is a Microsoft Windows® based system, such as Windows 2000, Windows XP, etc., but may be any other appropriate operating system (MAC O.S., UNIX, etc.) as discussed above. Preferably, the operating system is configured (i.e., contains a software program or instructions) to recognize the programming device 10 as a storage device or new “drive” once the preferred USB port 21 of the device 10 is coupled with the computer USB port 8 (i.e., through cable 25). As such, a user may use the “click, drag and drop” method to write code files F_{L} located within the computer 2 to the flash memory 14, as is well known to those skilled in the computer sciences and programming arts.

Further, the file-generation program P is preferably a text editor or word processor provided or “bundled” with the operating system software, but may be an application specific program that has been specifically written for a particular construction of the lock system 1 or/and programming device 10. Preferably, the computer 2 further includes a keyboard 68 or other input appropriate device (e.g., mouse, touchscreen, etc.) operably connected with the CPU 5 so as to enable entry of user input to create data files F_{L} using the computer program P. Furthermore, the file generation program P is preferably configured to generate one or more files F_{L} each containing at least one lock code C_{L}, and preferably a plurality of different lock codes C_{L1}, C_{L2}, etc., the specific number “n” of the codes C_{L} within each file F_{L} being determined as desired by the user. For example, with a lock system 1 including ten locks 3 (only one shown), a user may create one, single data file F_{L} containing a desired number of lock codes C_{L} (e.g., five, ten, or twenty codes C_{L}) that are loaded into each and every one of the ten lock controls 4 by the programming device 10. Alternatively, the user may create two or more data files F_{L1}, F_{L2}, etc. each containing one or more different lock codes C_{L}, which are loaded into different locks (e.g., file F_{L1} loaded into five locks 3, file F_{L2} loaded into the other five locks 3, etc.). As a further alternative, ten separate, different data files F_{L1}, F_{L2}, . . . F_{L10} may be created and each loaded into a separate one of the ten locks 3. Such lock management schemes may be implemented for any number of locks 3 and/or may be otherwise arranged or configured as desired by the user, the scope of the present invention embracing any and all lock management schemes that may desired a user of the lock system 1.

Referring now to FIGS. 1, 4, and 7-11, the flash memory 14 of the programming device 10 is preferably configured to receive and store a plurality of the lock code files F_{L} (e.g., F_{L1}, F_{L2}, F_{L3}, etc.), the files F_{L} having any appropriate configuration as described above. Preferably, the flash memory 14 includes one or more semiconductor chips 70 mounted on the rear surface 36b of the circuit board 36; most preferably, each flash memory chip 70 is a DataFlash® Model No. AT45DB642 or AT45DB321 chip commercially available from ATMEL Corporation of San Jose, Calif. The controller 16 preferably includes a commercially available microprocessor 72 mounted on the circuit board rear surface 36b, most preferably a Model No. AT89C5132/131 available from ATMEL Corporation. Although the above-noted AMTEL components are presently preferred, the programming device 10 may instead include any other flash memory chip(s) 70 and/or microprocessor(s) 72 from any other manufacturer (or even specially manufactured components), and the present invention is in no manner limited to having any particular chip components 70 or 72. Furthermore, the USB port 21, the serial BHN 19 or iButton pins 23a, and the iButton reader port 29 are each connected with separate pins of the microprocessor 72, preferably by means of electric lines on the circuit board 36. The microprocessor 72 preferably includes software (e.g., firmware) configured to transfer data to and from the flash chip(s) 70 and through each of the interface devices 20, 22. Additionally, the iButton reader 29 is preferably mounted on the front surface 36a of the circuit board 36, extends partially through the base front shell 33A, and is electrically coupled with the controller microprocessor 72. Preferably, the iButton reader 29 is a commercially available component, most preferably a Model number DS1402D-041 from Dallas Semiconductor/Maxim Integrated Products of Sunnyvale, Calif., but may alternatively be any other commercially available or specially manufactured device.

Further, the input device 24 preferably includes a keypad 76 with a plurality of keys 78 extending through the base housing 32 and a plurality of associated switch contacts 79 disposed on the circuit board front surface 36a and electrically coupled with the microprocessor 72. The display 26 preferably includes an LCD screen 80 with a backlight 82, the screen and backlight assembly 80, 82 being mounted on the front surface 36a of the circuit board 36 and connected with the microprocessor 72 by means of a connector 83. Furthermore, the programming device 10 also preferably comprises a “real time” clock 84 including a microprocessor 86 and a quartz crystal clock oscillator 88, and a buzzer or beeper 90 configured to generate an audible signal, preferably to provide process feedback to the user (e.g., when a file transfer is complete, etc.).

Additionally, the microprocessor 72 also includes appropriate software written to display an indication of the identity of the specific data files F_{L1}, F_{L2}, etc., located within the flash memory 14 (see FIG. 10), to enable a user to separately select each one, or groups, of the plurality of files F_{L}, and to transmit the selected file(s) F_{L} to a lock control 4. Preferably, the microprocessor 72 further includes software designed to receive “audit trail” information from each of the locks 3 and to display the information on the screen 78 or/and to store the audit trail information as data files within the flash memory 14 for subsequent transfer to the computer 2 or another appropriate device.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined generally in the appended claims.

We claim:

1. A lock programming device for use with a lock system, the lock system including a computer and at least one door lock having a control, the computer having a random access memory, a storage device and a program loadable into the random access memory for generating data files in response to user input, each data file corresponding to at least one lock code, the lock control having a memory for storing at least one lock code data file, the lock control being configured to operate the lock when the control receives an input corresponding to the stored code file, the programming device comprising:
a mobile base;
a flash memory connected with the base and configured to store at least one data file; and
a controller connected with the base, coupled with the flash memory and coupleable with the computer, the controller being configured to communicate with the computer such that at least one data file located in the random access memory is writable generally directly to the flash memory and configured to communicate with the lock control such that the data file is transferable from the flash memory to the lock control memory.

2. The programming device as recited in claim 1 wherein the mobile base is sized to be generally disposed within a hand of a user

3. The programming device as recited in claim 1 wherein the computer has an operating system configured to directly write a data file from the random access memory to the flash memory when the controller is coupled with the computer.

4. The programming device as recited in claim 3 wherein each data file located in the computer random access memory is at least one of generated by the program and retrieved from the storage device.

5. The programming device as recited in claim 1 wherein the computer further has a central processing unit and an operating system configured to recognize the programming device as a storage drive coupled with the central processing unit when the controller is coupled with the computer.

6. The programming device as recited in claim 1 wherein at least one data file generated by the computer program contains a plurality of lock codes and the lock control is configured to operate the lock when the control receives an input corresponding to any one of the lock codes when the one file is stored in the lock control memory.

7. The programming device as recited in claim 1 wherein at least one data file generated by the computer program contains a plurality of lock codes, the lock system includes a plurality of locks, and the programming device is configured to transfer the one data file to each one of the plurality of locks.

8. The programming device as recited in claim 1 further comprising:
a first interface device electrically connected with the controller and coupleable with the computer such that the computer transmits the at least one data file from the computer memory through the first interface device to the flash memory; and
a second interface device electrically connected with the controller and electrically connectable with the lock control such that the controller transmits the at least one data file from the flash memory, through the second interface device to the lock control.

9. The programming device as recited in claim 1 wherein the computer has a USB port and the programming device further comprises a USB port electrically connected with the controller and electrically connectable with the computer USB port such that the computer transmits data files from the computer memory, through the connected USB ports, and to the flash memory.

10. The programming device as recited in claim 9 further comprising a power supply having a battery and being electrically connected with the USB port, the controller and the flash memory, the power supply being configured to draw electric current from the battery when the battery voltage is greater than the voltage at the USB port and to draw electric current from the USB port when voltage at the USB port is greater than the battery voltage.

11. The programming device as recited in claim 1 further comprising a serial port electrically connected with the controller and electrically connectable with the lock control such that the controller transmits data files from the flash memory, through the serial port, and to the lock control.

12. The programming device as recited in claim 1 wherein:
the flash memory is configured to store a plurality of data files each corresponding to at least one separate lock code; and
the programming device further comprises an input device coupled with the controller and configured to operate the controller to separately select at least one of the data files from the flash memory and to transmit the selected data file to the lock control.

13. The programming device as recited in claim 12 further comprising a display operably coupled with the controller and the controller is configured to generate and transmit the display at least one of an indication identifying each data file stored within the flash memory and an indication of a status of a file transmission from the flash memory to the lock control.

14. The programming device as recited in claim 1 wherein the computer program is one of a text editor, a word processor and an application specific program.

15. The programming device as recited in claim 1 wherein the base includes a housing having an interior cavity, the flash memory and the controller being generally disposed within the cavity.

16. The programming device as recited in claim 1 wherein the base is movable between a first location proximal to the computer and a second location proximal to the lock.

17. The programming device as recited in claim 1 wherein:
the lock includes a moveable lock member displaceable between a first, locked position and a second, unlocked position, and an actuator configured to displace the lock member between the first and second positions; and
the lock control is configured to operate the actuator when the control receives an input corresponding to the stored code.

18. The programming device as recited in claim 1 wherein:
the lock system includes a plurality of locks, each lock control being configured to store at least one code data file;
the flash memory is configured to store a plurality of data files; and
the controller is configured to separately select each one of the plurality of data files within the flash memory and to transmit each selected file to a separate one of the lock controls.

19. The programming device as recited in claim 18 wherein each lock control is configured to store a plurality of code data files and the controller is configured to transmit a selected plurality of data files to each one of the separate lock controls.

20. A lock programming device for use with a lock system, the lock system including a computer and at least one door lock having a control, the computer having a central processing unit with a random access memory, a storage device, an operating system and a program loadable into the random access memory for generating data files in response to user input, each data file corresponding to at least one lock code, the lock control having a memory for storing at least lock code data file, the lock control being configured to operate the lock when the control receives an input corresponding to the stored code file, the programming device comprising:
a mobile base sized to be generally disposed within a hand of a user; and
a flash memory connected with the base, configured to store at least one data file, coupleable with the computer, recognizable by the computer operating system as a storage device such that at least one data file located in the random access memory is writable generally directly to the flash memory, and configured to communicate with the lock control such that the data file is transferable from the flash memory to the lock control memory.

21. A lock system comprising:
a computer having a random access memory, a storage device and a program loadable into the random access memory for generating data files in response to user input, each data file corresponding to at least one lock code;
a lock including a control having a memory for storing at least lock code data file, the lock control being configured to operate the lock when the control receives an input corresponding to the stored code file; and
a programming device including a mobile base sized to be generally disposed within a hand of a user and a flash memory connected with the base, the flash memory being configured to store at least one data file, the programming device being configured to communicate with the computer such that at least one data file located in the random access memory is writable generally directly to the flash memory and configured to communicate with the lock control such that the data file is transferable from the flash memory to the lock control memory.
